(19) United States
(12) Patent Application Publication
(10) Pub. No.: US 2025/0276282 A1
(43) Pub. Date: Sep. 4, 2025

(54) SYSTEMS AND METHODS FOR PREVENTING COLORED EMISSIONS IN CHEMICAL PROCESSES

(71) Applicant: WP&E Technologies and Solutions, LLC, Flowery Branch, GA (US)

(72) Inventor: Harikrishnan Parthasarathy, Flowery Branch, GA (US)

(21) Appl. No.: 19/066,746

(22) Filed: Feb. 28, 2025

Related U.S. Application Data
(60) Provisional application No. 63/560,609, filed on Mar. 1, 2024.

(51) Int. Cl. B01D 53/68; B01D 53/79

(52) U.S. Cl. CPC B01D 53/68; B01D 53/79; B01D 2251/20; B01D 2251/304; B01D 2251/60; B01D 2257/202; B01D 2257/204; B01D 2258/0283

(57) ABSTRACT

Systems and methods for reducing or mitigating violet or pink emissions are provided. In one aspect, a system comprises a process component that produces a process stream comprising iodines; an emissions component configured to process and exhaust emissions comprising iodine or iodide; and a reducing agent injection component configured to inject a reducing agent into the system at a point before a stream comprising iodide is received by the emissions component. In another aspect, a method comprises producing, by a process component, a process stream comprising iodines; injecting a reducing agent into the process stream comprising iodines and generating an emissions stream comprising iodides; receiving, by an emissions component, the emissions stream comprising iodides; and processing the emissions stream.

### RELATED APPLICATION DATA

This application claims the benefit of priority to U.S. Provisional Patent Application No. U.S. 63/560,609, titled SYSTEMS AND METHODS FOR PREVENTING COLORED EMISSIONS IN CHEMICAL PROCESSES, which was filed on Mar. 1, 2024, which is incorporated by reference herein in its entirety.

### FIELD

This disclosure generally relates to chemical processes or systems, more particularly, to decrease, mitigate, or prevent colored emissions in industrial processes or systems.

### BACKGROUND

In some industrial processes, where the input materials or intermediate materials have halogens (e.g., fluorine atoms, chlorine atoms, bromine atoms, iodine atom) or halides, the physics and/or arrangement of the system and/or the chemical reaction(s) of the industrial process(es) result(s) in concentrations, volumes, streams, or emissions with unwanted characteristics and/or components.

For example, some industrial processes and systems (such as those for the production of phosphoric acid and ammoniated phosphate products, e.g., fertilizers) utilize phosphate ore as a raw material. In some instances, if the raw material phosphate ore contains iodides, such processes or systems can produce products or byproducts which can result in violet or pink colored gas emissions or fumes. In other instances, if the raw material phosphate ore contains other halogens or halides, such processes or systems also can result in emissions (e.g., liquid or gas emissions or streams) with unwanted characteristics and/or components. More specifically, in other instances, if the raw material ore contains halide compounds or complexes (e.g., fluoride compounds or complexes or mixtures, chloride compounds or complexes or mixtures, bromide compounds or complexes or mixtures, iodide compounds or complexes or mixtures) such processes or systems also can result in emissions (e.g., liquid or gas emissions or streams like) with unwanted characteristics and/or components such as colored gas emissions or fumes, but also acidic and corrosive emissions and streams that are and harmful to health and environment (e.g. hydrofluoric acid/hydrogen fluoride and/or hydrogen with other halides.

In some cases, it is practically and/or economically unfeasible for these processes or systems to avoid utilizing base phosphate ore or rock containing iodine or iodide compounds or complexes, for example, because unfortunately some phosphate ore seams have iodine or iodide compounds or complex concentrations, which are naturally occurring, and which are provided to the industrial processing or production systems. Accordingly, there is a need in the art for systems and methods for reducing and/or preventing violet or pink colored emissions or fumes as a product or byproduct of the processing of phosphate ore containing iodine or iodide compounds or complex.

### SUMMARY

This summary is provided to introduce a selection of concepts or aspects in a simplified form that are further described below in the detailed description. This summary is not intended to identify key features or essential features of the claimed subject matter, nor is it intended to be used in isolation as an aid in determining the scope of the claimed subject matter.

Certain aspects according to the present disclosure are directed towards systems and methods for decreasing, mitigating, or preventing colored emissions from a chemical process or system. Certain aspects according to the present disclosure also are directed towards systems and methods for decreasing, mitigating, or preventing molecular halogen emissions from a chemical process or system. Moreover, certain aspects according to the present disclosure are directed towards systems and methods for inhibiting or preventing halide ions from converting into molecular halogen.

Furthermore, certain aspects according to the present disclosure are directed towards systems and methods for capturing halogens in a chemical process or system. Certain aspects according to the present disclosure also are directed towards systems and methods for redirecting halogens from gaseous emissions to other components or streams in a chemical process or system. Moreover, certain aspects according to the present disclosure are directed towards systems and methods for collecting and concentrating halogens in sub-components or sub-streams or sub-reservoirs, of a chemical process or system. Moreover, certain aspects according to the present disclosure also are directed towards systems and methods for collecting and concentrating halogens from sub-components or sub-streams or sub-reservoirs, of a chemical process or system, to other sub-components, sub-streams, sub-reservoirs of the chemical process or system.

As such, in one aspect, systems and methods according to the present disclosure are directed towards systems and methods for decreasing, mitigating, or preventing violet or pink colored emissions from a chemical process or system.

In another aspect, systems and methods according to the present disclosure are for decreasing, mitigating, or preventing molecular iodine emissions from a chemical process or system.

In another aspect, systems and methods according to the present disclosure are for inhibiting or preventing iodide anions from converting into: molecular iodine that can be visibly violet or pink; and/or into iodide compounds and complexes that could be visibly colored (e.g., iodine pentafluoride), in an emissions portion or sub-process of a chemical process or system.

In another aspect, systems and methods according to the present disclosure are for redirecting or capturing iodides or iodide ions in a chemical process or system.

In another aspect, systems and methods according to the present disclosure are for redirecting iodides or iodide ions from gaseous emissions to other components or streams in a chemical process or system.

In another aspect, systems and methods according to the present disclosure are for collecting and concentrating iodides or iodine ions in sub-components or sub-streams or sub-reservoirs, of a chemical process or system.

In another aspect, systems and methods according to the present disclosure are for collecting and concentrating iodides or iodine ions from sub-components or sub-streams or sub-reservoirs, of a chemical process or system, and transferring them to other sub-components, sub-streams, sub-reservoirs of the chemical process or system.

In another aspect, systems and methods according to the present disclosure inhibit the oxidation of iodide anions in a target industrial process(es) without necessarily stopping desired oxidation reactions (e.g., those oxidation reactions not necessarily involving iodine) in the target industrial process(es). Conventional systems and methods make it difficult and expensive to even attempt to balance these competing interests (e.g., expensive to try, with inefficient results that usually result in a less effective overall industrial process(es), due to sacrificed oxidation conditions).

In one aspect, systems and methods according to the present disclosure reduce molecular iodine, for example, if still present or inevitably formed in a target industrial process(es), back to an iodide anion without the usual corrosive or deleterious effects of reduction reactions (e.g., excessive heat production, uncontrolled or harmful pressure in system components, pH change damage or unwanted byproducts to the target industrial process(es)). Conventional chemical reduction systems and methods are usually very corrosive, in particular, to condensation towers and/or emissions stacks, and/or to system components (e.g., scrubbers and related equipment for the target industrial process(es)).

In one aspect, systems and methods according to the present disclosure, in a stage, inhibit, mitigate, or reduce the reaction rate of, oxidation of iodide anions in a target industrial process(es) without necessarily stopping desired oxidation reactions, and, in a separate stage, reduce molecular iodines to ionic form (e.g., an iodide anion) without the usual corrosive or deleterious effects of reduction reactions.

In one aspects, systems and methods according to the present disclosure are implemented to convert iodine from a chemical process into iodide anions. More specifically, in another aspect, systems and methods according to the present disclosure are implemented to reduce molecular iodine to iodide anion. Therefore, in another aspect, systems and methods according to the present disclosure are implemented to reduce halogen compounds and complexes into ionic form using a reducing agent.

In one aspects, systems and methods according to the present disclosure involve use of at least one of sodium sulfite, sodium bisulfite, sodium metabisulfite, sodium thiosulfate, sodium phosphate and triphosphates, sodium hydroxide and similar salts and complexes of alkali and alkali earth chemicals

In one aspect, systems and methods according to the present disclosure preferably involve use of at least one of sodium sulfite or sodium thiosulfate.

In one aspect, systems and methods according to the present disclosure preferably involve use of sodium sulfite. In particular, systems and methods according to the present disclosure preferably involve use of sodium sulfite if sulfur residues are a concern.

In one aspects, systems and methods according to the present disclosure comprise: a process component, the process component producing a process stream comprising iodine(s) or iodide ion(s), an emissions component, the emissions component configured to process and exhaust emissions comprising iodine or iodide ions, and a reducing agent injection component configured to inject a reducing agent into the system at a point before the stream comprising iodine or iodide ions is received by the emissions component.

In one aspect, systems and method according to the present disclosure redirect iodine(s) or iodide ion(s) from portions of the system that are upstream of the gaseous emissions portion/step, and/or inhibit or prevent the ready oxidation of iodide ions present in portions of the system that are upstream of emissions portion/step (e.g., at the reactors or reaction tanks or system tanks, or at the vents of the vacuum pumps, for example). More specifically, in one aspect, related to the reactors or the reaction tanks or system tanks, these upstream components are exposed to atmospheric or ambient through openings or vents. As such, emissions through these openings or vents are colored, for example, and the inventive chemical solutions according to the present disclosure are applicable to this upstream point.

More specifically, in one aspect, related to the vents of the vacuum pumps, these upstream components typically involve use of a liquid ring seal (e.g., seals formed by liquids instead of by solids, for example, a grommet). As such, the inventive concepts according to the present disclosure are applicable to this upstream point by injecting the chemical solution(s) described herein directly into the liquid used for the liquid ring seal.

Additional objects, advantages, and novel features of the invention will be set forth in part in the description which follows, and in part will become apparent to those skilled in the art upon examination of the following, or can be learned by practice of the invention.

### BRIEF DESCRIPTION OF THE DRAWINGS

Aspects of the technology presented herein are described in detail below with reference to the accompanying drawing figures, wherein:

FIG. 1 illustrates an example chemical process, in accordance with some aspects of the present technology;

FIG. 2 illustrates an example chemical process system, in accordance with some aspects of the present technology;

FIG. 3 illustrates an example reducing agent component or system, in accordance with some aspects of the present technology;

FIG. 4 illustrates an example implementation of a portion of a chemical process system, in accordance with some aspect of the present technology; and

FIG. 5 illustrates an example implementation of a portion of a chemical process system, in accordance with some aspect of the present technology.

FIG. 6 illustrates a schematic of the inventive solution as implemented to prepare the desired concentration of active ingredient in the solvent to inject into the process stream to remove violet/pink color emissions.

FIG. 7 illustrates a schematic of the injection of scrubbing solution, e.g. solvent or active ingredient, at predetermined concentration into the gas scrubber or process stream to remove iodine and remove color in the fumes.

FIG. 8 illustrates a graphic illustration showing the performance of the inventive solution when implemented.

FIG. 9A illustrates a photo showing gaseous emissions before implementation of the inventive solution.

FIG. 9B illustrates a photo showing gaseous emissions after implementation of an example of the inventive solution.

### DETAILED DESCRIPTION

This disclosure generally relates to chemical processes or systems, more particularly, to decrease, mitigate, or prevent colored emissions in industrial processes or systems.

This disclosure also generally relates to chemical processes or systems, more particularly, to decrease, mitigate, or prevent molecular halogen from being emitted in industrial processes or systems.

Moreover, this disclosure generally relates to chemical processes or systems, more particularly, to redirect halogens from gaseous emissions to other components or streams in industrial processes or systems.

Moreover, this disclosure also generally relates to chemical processes or systems, more particularly, to inhibit or prevent the ready oxidation of halide ions in the emissions portion/step, for example, of industrial processes or systems.

Furthermore, this disclosure generally relates to chemical processes or systems, more particularly, to redirect halogens from portions of the system that are upstream of the gaseous emissions portion/step, and/or to inhibit or prevent the ready oxidation of halide ions present in portions of the system that are upstream of emissions portion/step (e.g., at the reactors or reaction tanks or system tanks, or at the vents of the vacuum pumps, for example).

Furthermore, this disclosure generally relates to chemical processes or systems, more particularly, to capture halogens in industrial processes or systems.

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps disclosed herein unless and except when the order of individual steps is explicitly described.

Accordingly, embodiments described herein can be understood more readily by reference to the following detailed description, examples, and figures. Elements, apparatus, and methods described herein, however, are not limited to the specific embodiments presented in the detailed description, examples, and figures. It should be recognized that the exemplary embodiments herein are merely illustrative of the principles of the invention. Numerous modifications and adaptations will be readily apparent to those of skill in the art without departing from the spirit and scope of the invention.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “5 to 10” or “5-10” should generally be considered to include the end points 5 and 10.

Further, when the phrase “up to” is used in connection with an amount or quantity; it is to be understood that the amount is at least a detectable amount or quantity. For example, a material present in an amount “up to” a specified amount can be present from a detectable amount and up to and including the specified amount.

Additionally, in any disclosed embodiment, the terms “substantially,” “approximately,” and “about” may be substituted with “within [a percentage] of” what is specified, where the percentage includes 0.1, 1, 5, and 10 percent. At a high level, embodiments of the present technology are directed towards mitigating, reducing, preventing, and/or inhibiting colored emissions (e.g. violet or pink emissions) occurring in and/or from a reaction process, such as a chemical reaction process, chemical production process, and/or an industrial process. In some embodiments, methods and systems described herein inhibit or reduce violet or pink emissions through systems and methods for inhibiting, preventing, or reducing the formation of iodine(s) in exhaust or emissions streams.

In some chemical processes and/or systems, such as industrial processes, it is desirable or typical to produce white or uncolored emissions or fumes, for example that emit from a stack or tower. However, in some systems or processes the emissions can be colored, for example fumes and/or emissions can have a pink or violet color, for instance when perceived by a human eye.

In certain industrial systems and/or processes, for example in the production of ammonium phosphate (e.g. fertilizer), input and/or intermediate materials can comprise iodine and/or iodide concentrations which can in some instances result in violet or pink colored emissions or fumes, which in some instances can be due to, in part, by the arrangement of the system and/or processes and/or the chemical mechanisms of reaction processes in the system and/or processes. Accordingly, in some instances, the input and/or intermediate materials comprise phosphate ore (e.g. a base material or base ore) or rocks which can comprise a concentration of iodides. In some of these systems or processes, iodides can be converted to iodine(s). As will be appreciated, iodides may be colorless, while iodine(s) are violet and/or pink.

As will be appreciated, compounds comprising iodine in its most common oxidation state I⁻ (e.g. iodide anion) are generally colorless. For example, the simplest compound of iodine is hydrogen iodide which is a colorless gas and can be produced through reacting iodine with another compound such as hydrogen sulfide or hydrazine, e.g. 2I₂+N₂H₄→/H₂O 4HI+N₂. Further, as will be appreciated, iodine can be used as a catalyst and/or activator in some industrial processes, for instance in the production of acetic acid and in the production of some polymers. Because iodide is readily oxidized, in certain industrial processes or systems comprising input materials and/or intermediate materials having iodide concentrations, chemical processes or reactions in an overall process can result in the oxidation of iodides into iodine which can result in violet or pink colored emissions or fumes. By way of example, certain industrial processes or systems can include or involve one or more processes or sub-processes that comprise the oxidation of iodide(s) into iodine(s) including iodine complexes, compounds, and/or mixtures. In some aspects, such iodine complexes, compounds, and/or mixtures (also referred to herein as iodine(s) or iodine intermediates) are not further processed, transformed, or changed, which in some instances can result in violet or pink colored emissions or fumes. In some embodiments of the present technology, systems are methods can be configured to prevent, inhibit, or reduce the conversion of I⁻ to I₂, e.g. inhibit the extent of oxidation of iodides to iodine(s) without stopping the reaction or removing all the iodides. In some other embodiments, systems and methods can be configured to convert I₂ back into I⁻, for example through reduction back into ionic form (e.g. reducing the amount of iodine(s) produced by a process or system.

In some processes or systems, iodides (I⁻) (also referred to herein as ionic iodide), either alone or as a part of a base, input, or intermediary material (e.g. CaI, HI), can be converted to molecular iodine (I₂), for instance through oxidation. In some other processes or systems, I₂ can be converted to I⁻, for instance through reduction. In some aspects, chemical process systems can produce I⁻ as a byproduct which may be emitted by the system, however, in the emissions process, when I⁻ is introduced to air or oxygen, I₂ is formed and as such the emissions can become violet or pink in color. According to some embodiments of the present technology, reducing agent components can be introduced at various points in a chemical process system to prevent, mitigate, inhibit, or otherwise reduce the formation of I₂ in exhaust or emissions streams and preventing emissions that are violet or pink in color.

In some processes or systems, one component or portion comprises stack emissions from gas or fumes produced by the process (e.g. chemical process), which can contain I₂, amongst other components (e.g. Fluorides, silica, chlorides, bromides, fluorine, chlorine, Bromine, CO₂, SOₓ, NOₓ) which are emitted through a stack, and are in some aspects acidic, e.g. acidic gas or fumes. In some conventional techniques, reduction of I₂ may be achieved through the use of alkaline materials (e.g. NaOH, KOH) pumped into the system, however, such materials cause issues in the system, for example corrosion or, for systems with pressurized or non-pressurized piping, pressure, and explosion concerns. Further, the addition of alkaline materials to an acidic gas from a process or system can cause high levels of reaction heat or heat generation.

In embodiments of the present technology, one or more reducing agents may be used, which can in some aspects prevent oxidation. In some aspects, a reducing agent can be about a pH of 7, or for example a pH from about 6 to 8.

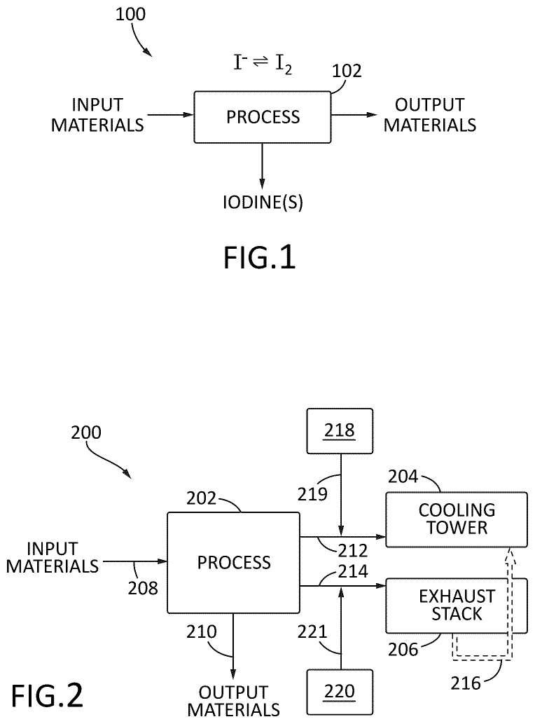

Referring now to the figures, FIG. 1 illustrates an example chemical process system 100 in accordance with some aspects of the present technology. In some aspects, chemical process system can be configured as an industrial process or production system. Chemical process system 100 can comprise a process component (also referred to as a reaction component) which can be implemented to react one or more input or raw materials and produce one or more output materials or chemical products. In some instances, the input materials to the chemical process system, or more particularly to the process component comprises iodides (I⁻). In some embodiments, the chemical process system or the process component can produce one or more byproducts due to the chemical reaction processes therein. In some instances, the one or more byproducts can comprise iodine(s) (I₂). For example, in the process of producing ammonium phosphate, the input materials include phosphate ore, which in some instances can include concentrations of iodides. During the chemical reaction process the iodides in the raw or base material phosphate ore can be converted to iodine(s) which may be exhausted from the system, along with one or more other byproducts of the chemical reaction process (e.g. CO₂, SOₓ, NOₓ). In some aspects, the iodine(s) or iodine concentration can be exhausted from the chemical process system by way of an exhaust stack and/or a cooling tower. As will be appreciated, in some aspects the presence of iodine(s) in the byproducts that are removed or exhausted from the system can cause the emissions to be colored, for example the emissions can have a violet or pink color.

FIG. 2 illustrates an example chemical process system 200, in accordance with some aspects of the present technology. Chemical process system 200 can include a process or reaction component 202 which can be configured to receive input materials and produce one or more output materials, for instance through one or more chemical reaction processes. Input materials (e.g. materials comprising iodides) can be received by the process component 202 via one or more input streams 208, and produce one or more output materials via one or more production streams 210. The chemical process system 200 can include one or more other components, for example one or more cooling towers 204 and one or more exhaust stacks 206. In some instances, an exhaust stack can include a scrubber system (e.g., a solvent scrubbing or active ingredient scrubbing system). In some aspects, a cooling tower 204 and/or an exhaust stack 206 can form at least a portion of one or more emissions components of chemical process system 200. Process component can additionally produce one or more intermediate products or byproducts, that can be fed to one or more other components of the system, such as cooling tower 204 and/or exhaust stack 206. In some embodiments, hot water from the process component 202 can be fed to the cooling tower 204 via a hot water stream 212. In some instances, hot water stream can include water and one or more additional components, for example iodides and/or iodine(s). In some embodiments, gas or exhaust from the process component 202 can be fed to the exhaust stack 206 via gas stream 214. In some instances, gas stream 214 can include a plurality of components, such as iodine(s), CO₂, SOₓ, NOₓ, amongst others. In some instances, the presence of iodine(s), in hot water stream 212 and/or gas stream 214, for example above some threshold concentration, can cause emissions from cooling tower 204 and/or exhaust stack 206 to be violet or pink in color. In some further instances, a product of the exhaust stack 206, such as water, can be fed to cooling tower 204 via recycle stream 216. In some embodiments, chemical process system can include one or more reducing agent components 218, 220 (also referred to as reducing agent injection components), which can be configured to inject or otherwise add one or more reducing agents into a portion of the system. In some embodiments, a reducing agent component 218 can add one or more reducing agents (or concentrations thereof) to a stream being provided to a cooling tower 204, for instance into hot water stream 212 via stream 219. Accordingly, a reducing agent can be provided to a stream of the system at a point prior to entering a cooling tower 204. In some other embodiments, a reducing agent component 220 can add one or more reducing agents (or concentrations thereof) to a stream being provide to an exhaust stack 206, for instance into gas stream 214 via stream 221. Accordingly, a reducing agent can be provided to a stream of the system at a point prior to entering an exhaust stack 206. As will be appreciated, chemical process system 200 can be configured with one or more reducing agent components or systems 218, 220. In some embodiments, chemical process system 200 can be configured with a single reducing agent component or system that can add, feed, and/or inject a reducing agent to both a stream being fed or provided to a cooling tower and/or a stream being fed or provided to an exhaust stack.

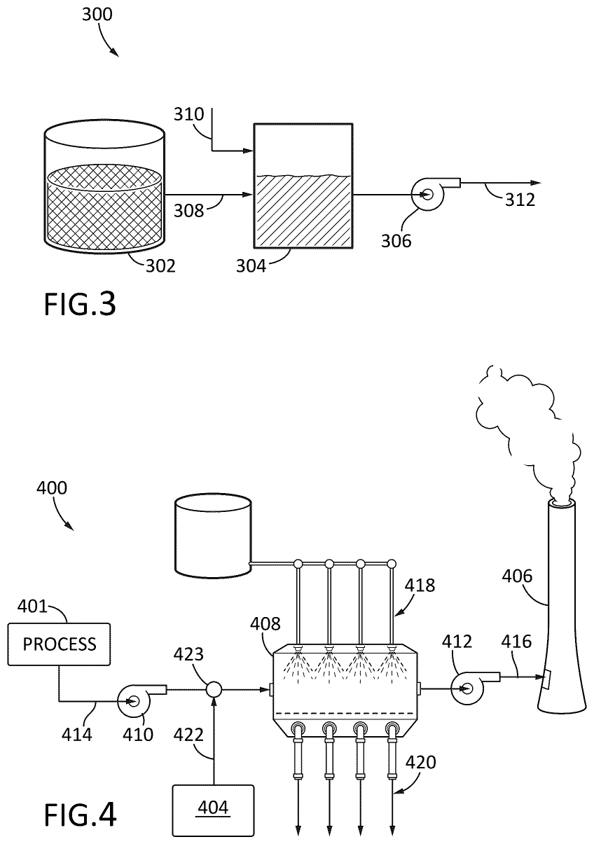

Referring to FIG. 3, an example reducing agent component or system 300 is illustrated, in accordance with some aspects of the present technology. Reducing agent component or system 300 can comprise a reducing agent holding tank 302, which can hold or store a bulk amount of a reducing agent composition (or solvent). In one embodiment, a reducing agent composition comprises sodium sulfite (Na₂SO₃) and water (H₂O). In some instances, reducing agent composition comprises 25% Na₂SO₃ and 75% H₂O. In some instances, reducing agent composition is made up of a solution comprising 250 kg of Na₂SO₃ and 750 kg of H₂O. Reducing agent component 300 can further comprise a diluted reducing agent tank 304, which can be implemented for temporarily holding an amount of diluted reducing agent composition (or solvent) and/or itself being utilized for diluting and/or mixing a reducing agent composition fed from reducing agent holding tank 302 via reducing agent stream 308. Diluted reducing agent tank or mixing tank or transient holding tank 304 can receive a reducing agent composition or solution via reducing agent stream 308 and can further receive water via water stream 310. In some instances, reducing agent composition and water can be added to diluted reducing agent tank or mixing tank 304 such that reducing agent composition is diluted, for example diluted 10×. In some embodiments, diluted reducing agent composition can comprise 2.5% Na₂SO₃ in aqueous solution. In some embodiments, diluted reducing agent composition comprises 25 kg Na₂SO₃ in 975 kg H₂O. In some instances, diluted reducing agent composition or solution can be as homogenous solution. In some other instances, diluted reducing agent composition can be heterogeneous. Reducing agent component or system 300 can further comprise a pump 306, which can be configured to pump diluted reducing agent solution from diluted reducing agent tank or mixing tank 304 to one or more components of a chemical process system (e.g. system 200 of FIG. 2) via reducing agent injection stream 312 (also referred to as reducing agent feed stream or reducing agent addition stream). Pump 306 can provide diluted reducing agent to at least one of a cooling tower and/or an exhaust stack (e.g. cooling tower 204 and/or exhaust stack 206 of FIG. 2) via injection stream 312. In some instances, diluted reducing agent can be provided to both a cooling tower and an exhaust stack. In some embodiments, more than one reducing agent component or system may be implemented in a chemical process system. In some embodiments, diluted reducing agent can be provided or injected into another stream of a chemical process system at a rate of at least 4000 liters per day (l/day), or in other embodiments up to a rate of 4000 l/day. In some embodiments, reducing agent component or system 300 can inject or add diluted reducing agent at a rate of about 4 to 5 liters per minute (l/min). In some other embodiments, reducing agent component or system 300 can inject or add diluted reducing agent at a rate of 10 l/min. This disclosure is not limited by a maximum or minimum amount, or by a maximum or minimum rate of, reducing agent or active ingredient that can be pumped or injected.

Referring now to FIG. 4, FIG. 4 illustrates an example implementation of a portion of a chemical process system 400, more particularly an exhaust stack component 402 and incorporating a reducing agent component 404. Exhaust stack component can comprise a scrubber 408 having one or more stages, an exhaust stack 406 for emitting gas(es) and one or more blowers 410, 410 to move gas(es) through the exhaust stack component 402 which can be received from chemical process 401, via exhaust feed stream 414. Scrubber 408 can receive one or more water feeds 418, for example via a spray, to facilitate a scrubbing process. In some aspects, one or more water feeds 418 are cooling water feeds. Additionally, scrubber 408 can produce, emit, or allow through-flow of the cooling water which can exit the scrubber via scrubber exit streams or water recycle streams 420. In some instances, the exit cooling water from the scrubber can comprise iodine(s). In some aspects, scrubber exit streams can be disposed of, or in some aspects, water recycle streams can be fed back into a chemical process system, for instance can be fed to a cooling tower component. Cooled gas(es) from the system (e.g. exhaust) can exit the scrubber via exhaust gas stream 416 and fed to one or more stack(s) 406 which can emit or exhaust gas(es) out of the system.

In some embodiments, chemical process system 400 can comprise a reducing agent component (e.g. reducing agent component 300 of FIG. 3) which can be configured to inject or add or feed a reducing agent or a diluted reducing agent to exhaust feed stream 414 via an injection stream 422 at injection point 423. As will be appreciated, injection point 423 is located at any point along the exhaust feed stream 414 prior to the gas(es) entering scrubber 408. In some embodiments, reducing agent or diluted reducing agent comprises Na₂SO₃. In some embodiments, reducing agent or diluted reducing agent comprises Na₂SO₃ and water. In some embodiments, diluted reducing agent is 2.5% Na₂SO₃ solution. In some embodiments, diluted reducing agent is provided to exhaust feed stream 414 at a rate of at least about 4 l/min, or at least about 5 l/min. In some other embodiments, diluted reducing agent is provided to exhaust feed stream 414 at a rate of at least about 10 l/min.

Without intending to be bound by theory, injection or addition of the diluted reducing agent (e.g. diluted Na₂SO₃) into a gas stream fed into a scrubber of an exhaust system or emissions stack, can in some aspects convert iodine(s) that are a byproduct of a chemical process or reaction which are present in the gas stream into iodides. Additionally, in some instances, as the reducing agent is fed or injected into the system prior to one or more scrubbing stages, iodine(s) that may be captured by cooling water in a scrubber system that may be provided or recycled back into a process or into a cooling tower, for example, may be reduced. Additionally, it will be appreciated that in a conventional scrubbing process, H₂O+12→H⁺I⁺ which may more readily be converted back into I₂ when exhausted through a stack as they are oxidized with air or oxygen. According to aspects of the present technology, by injecting a reducing agent at an injection point prior to the scrubbing process, I₂ in an exhaust gas feed stream proceeds along the reaction scheme Na₂SO₃+I₂→Na⁺I⁺ which has stronger bonding characteristics than H⁺I⁺, and as such is a stronger bond which is harder or more difficult or less readily convertible back into I₂ through an oxidation process. As such, Na⁺I⁺ exhausted through a stack is less likely, or inhibited, to convert back to I₂ when the exhaust or emissions gas stream is introduced to air. Accordingly, the emissions from a stack may not contain above a threshold concentration of I₂ will be white or colorless, which is in contrast to emissions from a conventional system which will convert to above a threshold amount of I₂ once the exhaust or emissions gas stream is introduced to air. In other words, by providing reducing agent to the system at an injection point prior to a scrubber component, I₂ in a gas feed are converted to Na⁺I⁺ which are not readily converted back to I₂ when emitted through a stack, and as such the stack emissions are white, colorless, or not violet, at least in part due to the absence of I⁻ and/or H⁺I⁺ in the emissions.

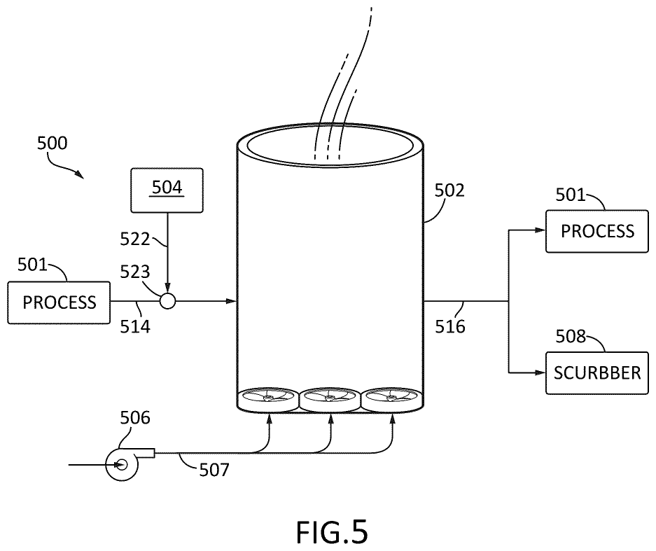

Turning now to FIG. 5, FIG. 5 illustrates an example implementation of a portion of a chemical process system 500, more particularly a cooling tower component and incorporating a reducing agent component 504. Cooling tower 502 can receive a hot water feed 514 from a chemical process 501, which can be a byproduct of such process. Hot water can be supplied to cooling tower 502 via hot water feed 514. Cooling tower 502 can comprise one or more pumps and/or fans 507 provide cooling air to cooling tower 502 to cool the hot water received from hot water feed 514. Subsequently, cooled water is provided out of the cooling tower 502 via cool water feed 516, which can then supply cool water back into chemical process 501, or alternatively in some instances, provide cool water to a scrubber, which may be a part of an exhaust stack component (e.g. 408 of FIG. 4). In some instances, hot water can be provided to cooling tower 502 from a scrubber (e.g. water recycle stream 420 of FIG. 4). In some instances, as will be appreciated, exhaust feed stream 414 may contain iodides (from the chemical process or from the scrubber) which are readily converted to iodine(s) in the cooling tower 502 from exposure to air or oxygen, and subsequently forming emissions in the form of steam which are violet or pink.

In some embodiments, chemical process system 500 can comprise a reducing agent component (e.g. reducing agent component 300 of FIG. 3) which can be configured to inject or add or feed a reducing agent or a diluted reducing agent to hot water stream or feed 514 via an injection stream 522 at injection point 523. As will be appreciated, injection point 523 is located at any point along the hot water feed or stream 514 prior to the hot water entering cooling tower 502. In some embodiments, reducing agent or diluted reducing agent comprises Na₂SO₃. In some embodiments, reducing agent or diluted reducing agent comprises Na₂SO₃ and water. In some embodiments, diluted reducing agent is 2.5% Na₂SO₃ solution. In some embodiments, diluted reducing agent is provided to exhaust feed stream 414 at a rate of at least about 4 l/min, or at least about 5 l/min. In some other embodiments, diluted reducing agent is provided to hot water feed or stream 514 at a rate of at least about 10 l/min. Without intending to be bound by theory, by injecting a reducing agent, such as sodium sulfite into a hot water stream or water stream (such as a hot water stream from a chemical process or a cooling water stream from a scrubber) the present methods and systems prevent the formation of I₂ in emissions from the chemical process system and thus prevent, reduce, and/or mitigate violet or pink colored emissions.

In other embodiments, the solvent (water diluted solution of sodium sulfite, sodium thiosulfate, sodium hydroxide, potassium hydroxide and versions or combination of alkali and alkali earth based composition, salts, or complexes) being utilized for pink/violet/purple color emissions in phosphoric acid manufacturing facility due to iodine from air and water streams is also demonstrating 80-99% removal of halogens (fluorine, chlorine, bromine, iodine) and its hydrogen halides. Halides can be hydrogen fluoride, chloride, bromide, iodides or sodium/potassium/calcium fluorides, chlorides, bromides, iodides or those combined complexes. These halides can be present in raw material for phosphoric acid and phosphate manufacturing and can be released in water and air or gas streams during manufacturing processes. The solvent composition (sodium sulfite in water; sodium thiosulfate in water, potassium hydroxide in water, sodium hydroxide in water or combination of all or mixtures thereof). This is injected in gas stream or air streams containing carbon dioxide, SO_{X}, NO_{X}, phosphates, silica, iodine, fluorine, chlorine bromine and its halides to eliminate the colored emissions (pink or purple or violet or combined color) from stacks and vents of equipment used in manufacturing processes. It can also be injected in water stream containing acids, phosphates, silicates, gypsum, iodine, fluorine, chlorine bromine and its halides and remove the pink color emissions, halogens and hydrogen halides (hydrogen fluoride, chloride, bromide and iodides). The pink/violet/purple emissions are formed when the water is exposed to ambient or atmosphere. For example, stored de-aerated or cooled through evaporative cooling like a cooling tower. These components are toxic, acidic and its presence highly regulated by environmental agencies and impact the safety, health and environmental standards of manufacturing facilities.

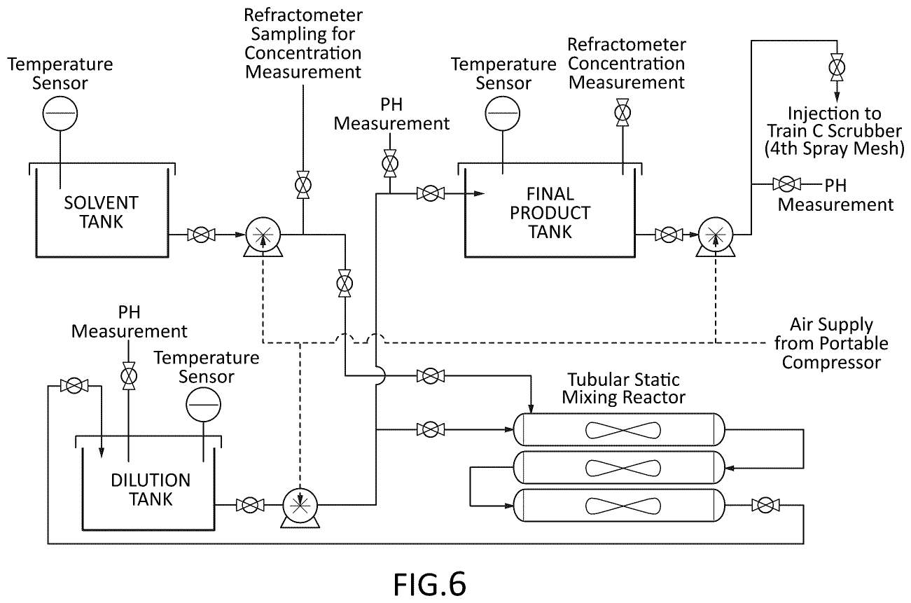

Turning now to FIG. 6, FIG. 6 illustrates a schematic of the inventive solution as implemented to prepare the desired concentration of active ingredient in the solvent to inject into the process stream to remove violet/pink color emissions. In one aspect, sodium sulfite, sodium thiosulfate, sodium or potassium hydroxide, are active ingredients in the solvent and are commercially available in powdered solid form (100% powder or flakes or granules) or in liquid form diluted with water (25-50% weight/weight (w/w)). In another aspect, the specific raw materials or active ingredients, are added alone or together in predetermined ratios from 1-100% w/w of each active ingredient. For example, in one aspect, the active ingredient can be a combination of 33.3% sodium or potassium hydroxide with 33.3% sodium thiosulfate and 33.4% sodium sulfite or can be a combination of 100% potassium hydroxide or 50% sodium sulfite and 50% potassium hydroxide. In another aspect, the composition of the combination is determined based on the concentration of the targeted halides and other constituents in the process stream.

In another aspect, as illustrated in FIG. 6, the active ingredient combination may be further mixed with water to achieve the desired concentration of active ingredients in solution (the solvent,) before it is injected into a customer process, for example, a Train C Scrubber mesh. Similarly, in another aspect, the solvent may be injected into other stack scrubbers or gas scrubbers or process streams as a scrubbing solution or solvent to remove Iodine and halogens from escaping into the atmosphere.

In another aspect, the raw material is added to the solvent tank. It is mixed with water to achieve less than 5-10% w/w, e.g. 5-10% by weight of active ingredient and 90-95% by weight of water. The ingredients are mixed slowly in the tank. Temperature is monitored in the tank through temperature sensor while ingredients are slowly added with water to prevent any excess heat generation during the mixing process. In another aspect, if needed, cold water can be used and ingredients are added slowly to prevent temperature rise beyond 130 degrees F. In another aspect, refractometers are available as quality control measurements to measure the quality of the solvent to ensure the desired concentration is achieved in the solvent tank.

In another aspect, as illustrated in FIG. 6, the 5-10% solution is pumped via a pump to the dilution tank through a mixing reactor. The mixing reactor has a series of built in static mixers inside a tube which enable good mixing of the active ingredient and water while it pumps through the mixing reactor. In another aspect, when the 5-10% concentrated solvent reaches the dilution tank, the pH is measured to ensure that the 5-10% solution is between 6-10. Moreover, in another aspect, the temperature sensor monitors the temperature.

In another aspect, as illustrated in FIG. 6, in the dilution tank, additional water is added to dilute the active ingredient further. In one aspect, the diluted active ingredient is in the range of 1-3% w/w in water in the dilution tank. In another aspect, there is a provision to pass this diluted ingredient to the mixing reactor to ensure proper mixing. From the dilution tank the 1-3% solution is pumped to the final product tank. In another aspect, in the final product tank, the pH is monitored to ensure pH is between 6-10 and temperature is monitored constantly. In another aspect, the concentration is also monitored by a refractometer to be in the 1-3% range.

In another aspect, as illustrated in FIG. 6, from the final product tank, the solvent at the desired or predetermined concentration is injected into the stack scrubbers to remove the targeted halogens and its associated color in the fumes and prevent it from escaping into the atmosphere.

In another aspect, the desired concentration of the active ingredient in the final product tank may range from 1-25% depending on the concentration of the targeted pollutants and other constituents in the process gas or liquid streams.

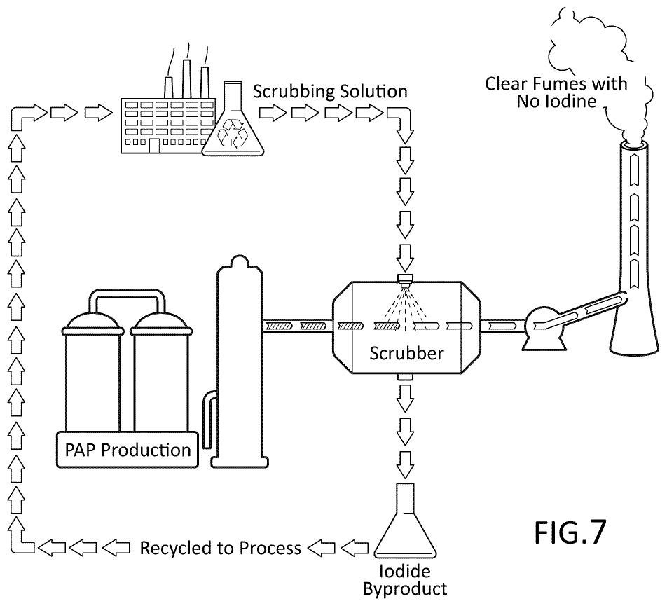

Turning now to FIG. 7, FIG. 7 illustrates a schematic of the injection of scrubbing solution, e.g., solvent or active ingredient, at predetermined concentration into the gas scrubber or process stream to remove iodine and remove color in the fumes. From the point of view of a conventional production plant (not illustrated), process stream gases usually contain iodine and halogen compounds, and these gases usually pass through a gas scrubber whose purpose is to remove halogen compounds and other constituents before the gas exits the stack. The presence of halogens like iodine causes violet or pink color fumes exiting the stack.

In one aspect, as illustrated in FIG. 7, a solvent or active ingredient(s) is/are injected into the scrubber in the form of a liquid at predetermined concentration. In one aspect, the solvent or active ingredient combination is prepared as described herein (for example, see FIG. 6). In another aspect, the solvent reacts with Iodine in gas form inside the scrubber and forms Iodide which gets dissolved in liquid form that exits the scrubber. In another aspect, the solvent also reacts similarly with halogens in gas in the scrubber and forms halides in liquid form. In another aspect, the liquid exiting the scrubber which can still contain residual unreacted active ingredient is recycled back to the scrubber and reused as solvent. In another aspect, fresh solvent is made up at the required concentration and added to the scrubbing solution as described herein (for example, see FIG. 6).

In another aspect, as illustrated in FIG. 7, the gas exiting the scrubber is essential or effectively or entirely free of Iodine or halogens and the related color.

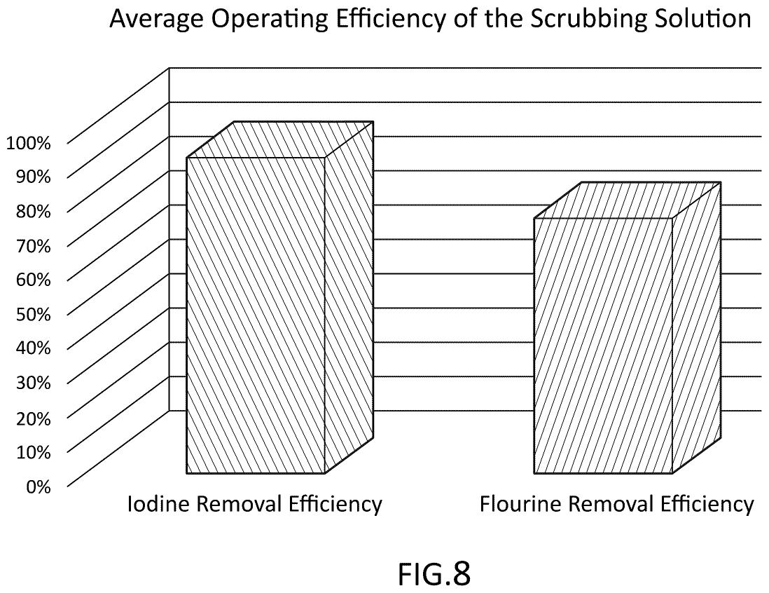

Turning now to FIG. 8, FIG. 8 illustrates a graphic illustration showing the performance of the inventive solution when implemented. In particular, in one aspect, the bar graphs should the average operating efficiency of the scrubbing solution for iodine removal and for fluorine removal.

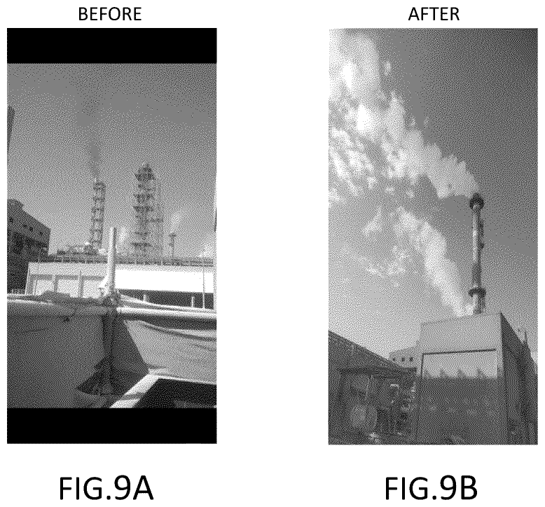

Turning now to FIGS. 9A and 9B, FIGS. 9A and 9B are two side by side illustrations of two photos showing the change in gaseous emissions for one implementation of the inventive solution. The left photo, FIG. 9A, shows the gaseous emissions before implementation of the inventive solution. The right photo, FIG. 9B, shows the gaseous emissions after implementation of the inventive solution.

Embodiments described herein can be understood more readily by reference to the examples described above. Elements, apparatus, and methods described herein, however, are not limited to any specific embodiment presented in the Examples. It should be recognized that these are merely illustrative of some principles of this disclosure, and are non-limiting. Numerous modifications and adaptations will be readily apparent without departing from the spirit and scope of the disclosure.

Many different arrangements of the various components and/or steps depicted and described, as well as those not shown, are possible without departing from the scope of the claims below. Embodiments of the present technology have been described with the intent to be illustrative rather than restrictive. Alternative embodiments will become apparent from reference to this disclosure. Alternative means of implementing the aforementioned can be completed without departing from the scope of the claims below. Certain features and subcombinations are of utility and can be employed without reference to other features and subcombinations and are contemplated within the scope of the claims.

The following constitutes notes and disclosure surrounding one practical implementations of some of the aspects according to the present disclosure:

Removal of pink/purple color visible emission from the Phosphoric Acid Plant stack is the goal.

Pink color emission was observed in the stack in the Phosphoric Plant manufacturing process. This same has been attributed to iodine content in the naturally extracted rock phosphate. Presence of Iodine in the stack gas imparts the typical pink color to the stack emissions This was not envisaged during the design phase of the plant. The visible pinkish/purple color releases continuously from stacks is leading to non-compliance to environmental regulatory standards and Environmental Permits.

Inventor explored various technologies to reduce the pink emissions. There was no proven technology to reduce pink emission from Phosphoric acid plants. Based on the in-house study, presence of Iodine was confirmed at target's Phosphoric Acid plants and various studies/trials conducted.

During a period of time, inventor was engaged and trials were conducted for removal of the pink emissions. The trials were successful and the results indicated that inventor's system and method can be added to the final stage scrubber on the stacks in small ppm doses. The inventive solution reacts with iodine or iodide ions in the stack flue gas from the reactors rendering the stack gas colorless. This is also found not to interfere with the production process nor had any negative impact. Regulatory authorities were invited to witness the trials and were found to be satisfactory. The permanent system installed is considered an innovation as no major changes in process or equipment were involved. This technology was not readily available or applied in Phosphoric Acid Plants around the world.

The benefits of this Innovation Technology are as given below:

No pink/purple color visible emission from the plant stacks.

No major changes in process and no impact on products quality.

Enables Environmental Regulatory Compliance.

Harmless soluble and recoverable iodide byproducts.

In addition to pink emissions, the solution also removes Fluorides and other flue gas contaminants. In one aspect, the working principle is as follows: [Iodides (molecular species, example Hydrogen Iodide or CaI or KI) which are Clear/Light Yellow in color]+[Air/Oxygen Oxidant]=>[Iodine (molecular species) which is Violet/Purple in color and can appear brown]

More specifically, in another aspect, a fraction of iodides present in the rock phosphate are converted to Iodine (molecular form) e.g. oxidized, during the Phosphoric Acid Production Process. This Iodine manifests as distinct pink/purple color emissions when flue gas exits the stacks when exposed to ambient air/oxygen source. For example, in one aspect, according the present disclosure, the Iodides (colorless) in PAP flue gas may become Iodine (pink/purple) from oxidation or interaction with air or oxygen; however, the solution as described herein converts the Iodine to colorless iodides that are not released or minimally released.

The estimated concentration of molecular Iodine was analyzed to be between 2-50 ppm. The pink color in the stacks were not noticed when the molecular Iodine concentration is reduced to less than 1 ppm in the flue gas. Since the scrubber water on the stack scrubbers are linked to the cooling tower, the pink emissions are manifested on the cooling tower as well. Measurements of Iodine were made using GASTEC/Draeger and using Iodine solvent absorption (converting iodine to iodides and measuring iodine concentration). The proprietary scrubbing solution according to certain aspects of the present disclosure is a stabilized combination of Sodium and Potassium salt with the following features:
Completely soluble in water;
Neutral PH;
Utilized in very small ppm level dosage in gas and water phase;
Stable at high temperatures in stack flue gases;
Able to react with other Halogens like Fluorine, Chlorine, Bromine and other components in gas phase and liquid phase very similar to Iodine;
Prevents Iodine to be produced in the system by inhibiting molecular iodine formation;
Safe and harmless to handle and use; and
Food Grade Constituents.

In certain aspects, the scrubbing solution is formulated onsite and mixed and stabilized utilizing PH, temperature and concentration control. The neutral stabilized solution is checked for PH and concentration in the final product tank before it is fed in ppm level doses to the Stack Scrubbers.

Certain implementations of systems and methods consistent with the present disclosure are provided as follows:

Clause 1. A system for reducing or mitigating violet or pink emissions comprising: a process component, the process component producing a process stream comprising iodines; an emissions component, the emissions component configured to process and exhaust emissions comprising iodine or iodide; and a reducing agent injection component configured to inject a reducing agent into the system at a point before a stream comprising iodide is received by the emissions component.

Clause 2. The system of clause 1, wherein the emissions component is at least one of an exhaust stack, a cooling tower and exhaust vent from reactor or vacuum pump.

Clause 3. The system of clause 2, wherein the exhaust stack comprises a scrubber.

Clause 4. The system of clause 1, wherein the reducing agent is a diluted solution of at least one of sodium sulfite, sodium thiosulfate, sodium hydroxide, potassium hydroxide and other similar alkali and alkali earth compositions.

Clause 5. The system of clause 1, wherein the reducing agent is present in an amount of 0.1-25% in solution.

Clause 6. The system of clause 1, wherein the reducing agent is injected at a rate of at least about 0.101/min.

Clause 7. The system of clause 1, wherein the reducing agent is injected at a rate of about 20 l/min.

Clause 8. The system of clause 1, wherein the iodide in the exhaust emissions are inhibited from converting to iodine(s).

Clause 9. The system of clause 1, wherein the iodine(s) in the process stream is converted to iodide(s).

Clause 10. A method for reducing or mitigating violet or pink emissions, the method comprising: producing, by a process component, a process stream comprising iodines; injecting a reducing agent into the process stream comprising iodines and generating an emissions stream comprising iodides; receiving, by an emissions component, the emissions stream comprising iodides; and processing the emissions stream.

Clause 11. The method of clause 10, wherein the emissions component is at least one of an exhaust stack and a cooling tower.

Clause 12. The method of clause 10, wherein the reducing agent is a diluted solution of at least one of sodium sulfite, sodium thiosulfate, sodium hydroxide, potassium hydroxide.

Clause 13. The method of clause 10, wherein the reducing agent is present in an amount of 2.5% in solution.

Clause 14. The method of clause 10, wherein the reducing agent is injected at a rate of at least about 4 l/min.

Clause 15. The method of clause 10, wherein the reducing agent is injected at a rate of about 10 l/min.

Clause 16. The method of clause 10, wherein the reducing agent is injected at a rate of about 10 l/min.

Clause 17. The method of clause 10, wherein the iodides in the emissions stream are inhibited from converting to iodine(s).

Clause 18. The method of clause 10, wherein the iodine(s) in the process stream is converted to iodide(s).

1. A system for reducing or mitigating violet or pink emissions comprising:
a process component, the process component producing a process stream comprising iodines;
an emissions component, the emissions component configured to process and exhaust emissions comprising iodine or iodide; and
a reducing agent injection component configured to inject a reducing agent into the system at a point before a stream comprising iodide is received by the emissions component.

2. The system of claim 1, wherein the emissions component is at least one of an exhaust stack, a cooling tower and exhaust vent from reactor or vacuum pump.

3. The system of claim 2, wherein the exhaust stack comprises a scrubber.

4. The system of claim 1, wherein the reducing agent is a diluted solution of at least one of sodium sulfite, sodium thiosulfate, sodium hydroxide, potassium hydroxide and other similar alkali and alkali earth compositions.

5. The system of claim 1, wherein the reducing agent is present in an amount of 0.1-25% in solution.

6. The system of claim 1, wherein the reducing agent is injected at a rate of at least about 0.10 l/min.

7. The system of claim 1, wherein the reducing agent is injected at a rate of about 20 l/min to about 1000 l/min.

8. The system of claim 1, wherein the iodide in the exhaust emissions are inhibited from converting to iodine(s).

9. The system of claim 1, wherein the iodine(s) in the process stream is converted to iodide(s).

10. A method for reducing or mitigating violet or pink emissions, the method comprising:
producing, by a process component, a process stream comprising iodines;
injecting a reducing agent into the process stream comprising iodines and generating an emissions stream comprising iodides;
receiving, by an emissions component, the emissions stream comprising iodides; and
processing the emissions stream.

11. The method of claim 10, wherein the emissions component is at least one of an exhaust stack and a cooling tower.

12. The method of claim 10, wherein the reducing agent is a diluted solution of at least one of sodium sulfite, sodium thiosulfate, sodium hydroxide, potassium hydroxide.

13. The method of claim 10, wherein the reducing agent is present in an amount of 2.5% in solution.

14. The method of claim 10, wherein the reducing agent is injected at a rate of at least about 4 l/min.

15. The method of claim 10, wherein the reducing agent is injected at a rate of about 10 l/min.

16. The method of claim 10, wherein the reducing agent is injected at a rate of about 1000 l/min.

17. The method of claim 10, wherein the iodides in the emissions stream are inhibited from converting to iodine(s).

18. The method of claim 10, wherein the iodine(s) in the process stream is converted to iodide(s).
